(19) United States
(12) Patent Application Publication
(10) Pub. No.: US 2023/0238641 A1
(43) Pub. Date: Jul. 27, 2023

(54) Secondary Battery

(71) Applicant: LG Energy Solution, Ltd., Seoul (KR)

(72) Inventors: Hun Hee Lim, Daejeon (KR); Sang Hun Kim, Daejeon (KR); Min Hyeong Kang, Daejeon (KR); Hyung Kyun Yu, Daejeon (KR)

(73) Assignee: LG Energy Solution, Ltd., Seoul (KR)

(21) Appl. No.: 18/009,552

(22) PCT Filed: Nov. 17, 2020
(86) PCT No.: PCT/KR2020/016190

§ 371 Date: Dec. 9, 2022

(30) Foreign Application Priority Data
Jun. 15, 2020 (KR) 10-2020-0072597

(51) Int. Cl. H01M 50/333; H01M 50/105; H01M 50/609; H01M 50/531; H01M 50/211

(52) U.S. Cl. CPC H01M 50/333; H01M 50/105; H01M 50/609; H01M 50/531; H01M 50/211

(57) ABSTRACT

A secondary battery includes an electrode assembly and an electrolyte that are inserted and injected into a pouch. An edge of the pouch is sealed to form a sealing portion. The secondary battery also includes a valve fixed to the sealing portion. The valve includes a body forming a passage having opened one end facing the inside of the pouch and provided with a chamber connected to the passage, wherein a discharge hole communicating with the outside is formed in the chamber. The valve also includes a gate seated on a hook protrusion forming a boundary between the passage and the chamber to open or close the passage. The valve also includes a spring mounted to apply elastic force in a direction in which the gate is closed.

### CROSS-REFERENCE TO RELATED APPLICATIONS

The present application is a national phase entry under 35 U.S.C. § 371 of International Application No. PCT/KR2020/016190 filed Nov. 17, 2020, which claims priority from Korean Patent Application No. 10-2020-0072597 filed on Jun. 15, 2020, all of which are incorporated herein by reference in their entireties.

### FIELD OF THE INVENTION

The present invention relates to a secondary battery in which an electrode assembly and an electrolyte are embedded in a pouch, and more particularly, to a pouch-type secondary battery having a valve capable of discharging a gas to the outside when the gas is generated in the pouch.

### BACKGROUND OF THE INVENTION

The demands for high-efficiency secondary batteries are rapidly increasing in the mobile device and electric vehicle fields. Among such the secondary batteries, a lithium secondary battery having high energy density, maintaining a relatively high voltage, and having a low self-discharge rate is commercially widely used, and research and development for improving performance thereof is actively being conducted.

The secondary battery has a structure in which an electrode assembly and an electrolyte are embedded in a case such as a can or a pouch. The electrode assembly has a structure in which positive electrodes, separators, and negative electrodes are repeatedly stacked. In general, the electrode assembly may be classified into a winding type electrode assembly in which the positive electrodes, the separators, and the negative electrodes, which are in the stacked state, are rolled to be embedded in the case and a stack type (stacked) electrode assembly in which the positive electrodes, the separators, and the negative electrodes, each of which is cut to a predetermined size, are stacked.

Since the winding type electrode assembly has a spirally wound structure, the winding type electrode assembly is suitable for being mounted on a cylindrical battery, but is disadvantageous in space utilization for a prismatic or pouch type battery. On the other hand, since the stack type electrode assembly is adjusted in size when the electrode and the separator are cut, the prismatic shape fitted with the case is easily obtained, but a manufacturing process is relatively complicated, and the stack type electrode assembly is relatively vulnerable to an external impact. Also, a stack & folding method has been developed to combine the advantages of the winding type and the stack type. In the stack & folding method, a C-type bicell (a bicell having a stack structure of a positive electrode/separator/negative electrode/separator/positive electrode) and an A-type bicell (a bicell having a stack structure of a negative electrode/separator/positive electrode/separator/negative electrode) are placed on a folding separator to fold the bicells, thereby manufacturing the electrode assembly.

The electrode assembly manufactured in various manners as described above is mounted in a case such as a can or a pouch.

Among them, the pouch-type battery has advantages such as higher energy density per unit weight and volume, enables thinner and lighter battery, as well as a lower material cost as an exterior, and thus has been actively developed in recent years. As illustrated in FIG. 1, which illustrates a state in which an electrode assembly 3 is mounted in a state in which a pouch 1 is opened, the pouch-type secondary battery is manufactured so that the electrode assembly 3 is seated in the pouch 1 in a state in which upper and lower portions of the pouch 1 are separated from each other, and when an electrolyte is injected, sealing portions 2a and 2b formed on edges of the upper and lower portions are sealed. Here, an end of an electrode lead 3a drawn out from the electrode assembly 3 is sealed in a state of being disposed to protrude to the outside.

The pouch-type battery has a problem in that swelling occurs during the charging/discharging in the manufacturing process and during the use as a charging/discharging device after the manufacturing is performed.

Such swelling is a phenomenon in which a gas is generated inside the pouch 1 due to the vaporization of the electrolyte to deform an outer appearance of the pouch 1 and deteriorate charge/discharge performance of the secondary battery, and in severe cases, there is a risk of explosion.

Therefore, when the gas is generated inside the pouch 1, it is necessary to remove the gas to the outside.

### BRIEF SUMMARY OF THE INVENTION SUMMARY

A secondary battery according to the present disclosure may solve the above described problem by having a valve capable of discharging a gas to the outside when the gas is generated inside a pouch to increase in internal pressure.

The present disclosure provides a secondary battery in which an electrode assembly and an electrolyte are inserted and injected into a pouch, and an edge of the pouch is sealed to form a sealing portion, the secondary battery comprising: a valve fixed to the sealing portion so that one end thereof faces the inside of the pouch, and the other end thereof faces the outside of the pouch, wherein the valve comprises: a body forming a passage having opened one end facing the inside of the pouch and provided with a chamber connected to the passage, wherein a discharge hole communicating with the outside is formed in the chamber; a gate seated on a hook protrusion forming a boundary between the passage and the chamber to open or close the passage; and a spring mounted to apply elastic force in a direction in which the gate is closed, wherein a gas is generated inside the pouch, and a pressure of the gas overcomes the elastic force of the spring, the gate is opened to discharge the gas through the discharge hole.

An O-ring may be mounted at a point of the hook protrusion, at which the gate is seated, so that sealing is achieved when the gate is closed.

A blocking film for preventing the electrolyte from being permeated may be mounted on the body at an inlet-side of the passage, and the blocking film may be torn or separated from a mounted position when a gas is generated inside the pouch to increase in internal pressure.

The blocking film may be made of a material that does not cause a chemical reaction with the electrolyte. The blocking film may be manufactured as a thin film made of polypropylene or polytetrafluoroethylene.

The blocking film may adhere to the body by using a pressure sensitive adhesive.

An auxiliary discharge hole may be formed so that when the gate slides inside the chamber, air within the chamber is discharged, wherein the auxiliary discharge hole may be formed at an opposite side of the discharge hole with the gate therebetween.

The gate may comprise a body seated on the hook protrusion and a pillar expanded form the body to protrude to be inserted into the passage, wherein a gasket having a ring shape may be fitted to an outer circumferential surface of the pillar to seal a gap between the outer circumferential surface of the pillar and an inner circumferential surface of the passage.

An inclined surface may be formed along a circumference of the pillar so that the gas is gradually introduced into the chamber while the pillar slides.

The valve may be disposed in parallel to an electrode lead that is drawn out from the electrode assembly to protrude out of the pouch.

The present invention may additionally provide a secondary battery module manufactured by coupling the plurality of secondary batteries having the above-described configuration to each other.

In the present invention having the configuration as described above, when the gas is generated inside the pouch, and the pressure of the gas overcomes the elastic force of the spring, the gate may be opened to discharge to the discharge hole, thereby efficiently preventing the swelling from occurring and preventing the moisture and the foreign substances from being introduced from the outside of the valve.

The O-ring may be mounted at the point of the hook protrusion, at which the gate is seated, to prevent the electrolyte from leaking.

Furthermore, the blocking film may be mounted on the inlet-side of the passage to fundamentally block the introduction of the electrolyte into the valve when the pressure inside the pouch is in the normal range.

The blocking film may be made of the material that does not cause the chemical reaction with the electrolyte to prevent the electrolyte from being deteriorated in performance.

In the valve according to the present invention, the auxiliary discharge hole may be formed in the opposite side of the discharge hole to prevent the air resistance from adversely affecting the sliding of the valve.

In addition, the gasket may be fitted into the gate to prevent the gas from leaking, and the inclined surface may be formed on the pillar so that the gas is gradually discharged.

### BRIEF DESCRIPTION OF THE DRAWINGS

FIG. 1 is a perspective view illustrating a state in which an electrode assembly is mounted in a state in which a pouch is opened.

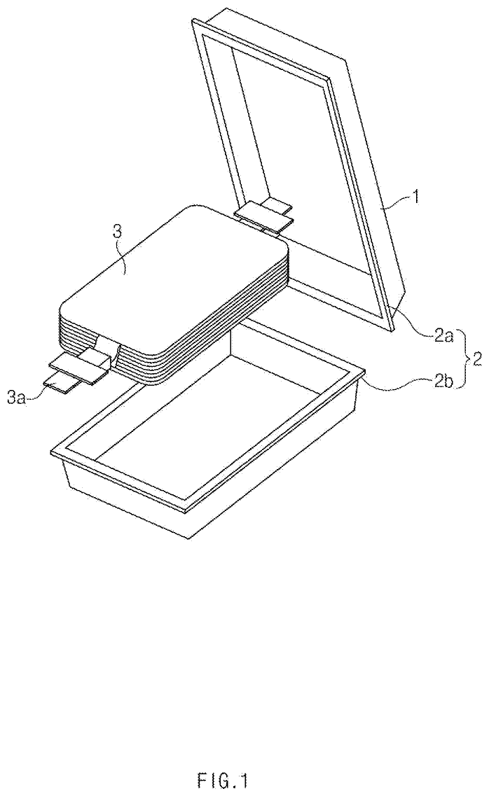

FIG. 2 is a view illustrating a state in which a valve is mounted in a secondary battery according to a first embodiment of the present invention.

FIG. 3 is a cross-sectional view (left) illustrating a state in which a gate is closed before a gas is generated in a pouch and a cross-sectional view (right) illustrating a state in which the gas is generated to open the gate by a pressure of the gas in the valve according to the first embodiment of the present invention.

FIG. 4 is a view illustrating more clearly a mounted state of a gasket in FIG. 2.

FIG. 5 is a cross-sectional view (left) illustrating a state in which a blocking film is mounted at an inlet-side of a passage and a cross-sectional view (right) illustrating a state in which the blocking film is separated from a mounted position according to a second embodiment of the present invention.

### DETAILED DESCRIPTION

Hereinafter, examples according to the present disclosure will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein.

In order to clearly describe the present invention, parts irrelevant to the description are omitted, and the same reference numerals are assigned to the same or similar components throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

The present invention relates to a secondary battery in which an electrode assembly and an electrolyte are inserted into a pouch, and an edge of the pouch is sealed to form a sealing portion. Hereinafter, embodiments of the present invention will be described in more detail with reference to the accompanying drawings.

### First Embodiment

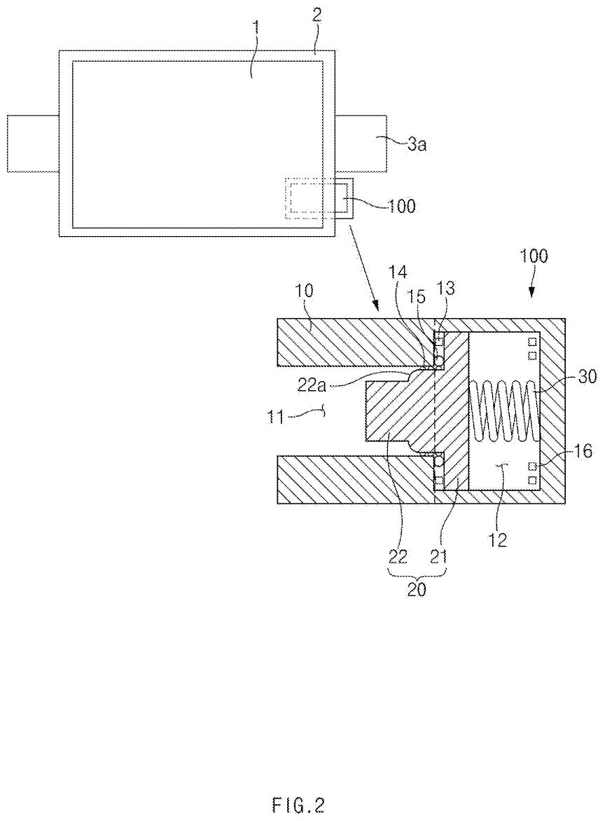

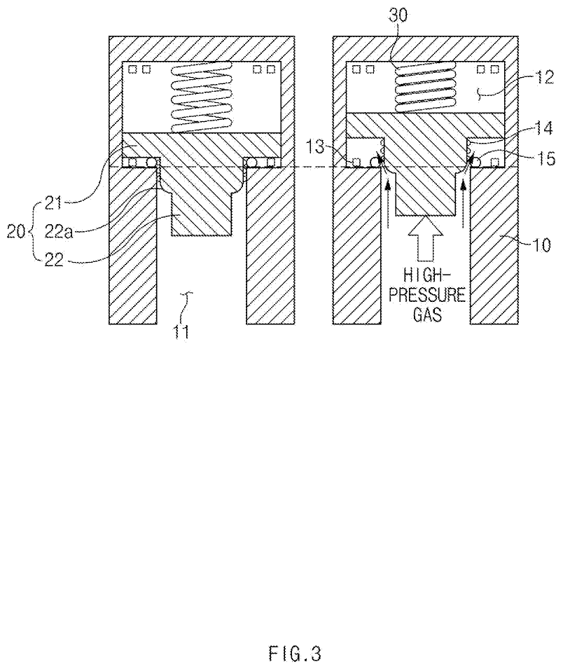

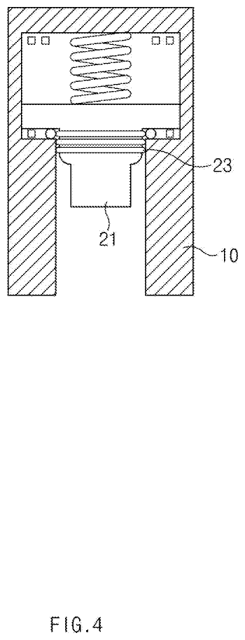

FIG. 2 is a view illustrating a state in which a valve is mounted in a secondary battery according to a first embodiment of the present invention, FIG. 3 is a cross-sectional view (left) illustrating a state in which a gate is closed before a gas is generated in a pouch and a cross-sectional view (right) illustrating a state in which the gas is generated to open the gate by a pressure of the gas in the valve according to the first embodiment of the present invention, and FIG. 4 is a view illustrating more clearly a mounted state of a gasket in FIG. 2.

Referring to the drawings, a secondary battery according to this embodiment comprises a valve 100, and the valve 100 is fixedly mounted so that one end thereof faces the inside of a pouch 1, and the other end thereof faces the outside of the pouch 1. Here, the valve 100 is disposed in parallel to an electrode lead 3a that is drawn out from the electrode assembly to protrude out of the pouch 1 at an interval.

The valve 100 has a structure in which a gate 20 is fixed to the sealing portion and mounted inside a body 10, in which a passage is formed, so that a gas is accessible.

That is, as illustrated in FIG. 3 in more detail, the body 10 has the passage having one end opened and facing the inside of the pouch 1 and the other end extending from the one end to the other side in a longitudinal direction, and the passage 11 is opened to a chamber 12.

The chamber 12 has a structure in which an end opposite to the end of the passage 11 is blocked, and a discharge hole 13 is formed so as to communicate with the outside in a portion of a sidewall. The valve 100 is fixed to the sealing portion in a state in which the discharge hole 13 is exposed to the outside. The body 10 is made of a metal, ceramic, a synthetic resin, or the like having excellent chemical resistance.

Also, the gate 20 is seated on a hook protrusion forming a boundary between the passage 11 and the chamber 12 to open or close the passage 11. The hook protrusion is a boundary point formed by a difference between an inner diameter of the passage 11 and an inner diameter of the chamber 12, and the gate 20 is mounted to shield the hook protrusion in the chamber 12.

The gate 20 is connected to a spring 30 so that elastic force acts in a direction in which the gate 20 is closed. The spring 30 is a compression spring that resists compression force and has one end fixed to a wall surface (disposed at an opposite side of the passage) of the chamber 12 and the other end fixed to the gate 20.

Thus, the gate 20 is opened only when force that overcomes the elastic force of the spring 30 is applied.

Also, an O-ring 15 is mounted at a point of the hook protrusion, at which the gate 20 is seated, so that sealing is achieved when the gate 20 is closed. When the gate 20 is closed, the O-ring 15 is pressed by the elastic force of the spring 30 and thus is elastically deformed to seal a gap that may occur between the gate 20 and the body 10.

Furthermore, an auxiliary discharge hole 16 is additionally formed so that air in the chamber 12 is discharged when the gate 20 slides inside the chamber 12. Since the auxiliary discharge hole 16 is formed at an opposite side of the discharge hole 13 with the gate 20 therebetween, when a space in which the spring 30 is disposed is contracted, the air may be discharged to the outside before being compressed prevent the sliding of the gate 20 from being disturbed by air resistance.

The gate 20 according to this embodiment comprises a disk-shaped body 21 that is seated on the hook protrusion and a cylindrical pillar 22 that is expanded from the body 21 to protrude to be inserted into the passage 11.

The body 21 shields a gap between the passage 11 and the chamber 12 when the gate 20 is in a closed state, and the pillar 22 extends from the body 21 so as to be inserted into the passage 11, thereby guiding the sliding of the body 21.

Furthermore, the pillar 21 has an inclined surface 22a along a circumference of the pillar 21 so that the gas is gradually introduced into the chamber 12 while the pillar 21 slides, and a contact area increases when the gas is introduced into the passage 11 to concentrate a pressure. The inclined surface 22a may be formed as a plane inclined at a predetermined angle or may be formed in a convexly rounded curved surface along the circumference of the pillar 22.

In addition, as more clearly illustrated in FIG. 4, a plurality of ring-shaped gaskets 23 may be fitted on an outer circumferential surface of the pillar 11 so as to be sealed between the outer circumferential surface of the pillar 11 and an inner circumferential surface of the passage 11.

Therefore, when the gas is in a normal pressure range before a gas is generated inside the pouch 1, the gate 20 shields the passage 11 by the elastic force of the spring 30 as illustrated in the left drawing of FIG. 3.

And, when the gas is generated inside the pouch 1 to increase in pressure inside the pouch 1, the gas pressure overcomes the elastic force of the spring 30 to push the gate 20, and thus, the gas is introduced into the chamber 12 as illustrated in the right drawing of FIG. 3 and then is discharged to the outside through the discharge hole 13. Here, an opening valve pressure of the gate 20, at which the gate is opened, may be variously set by adjusting the elastic force of the spring 30.

Furthermore, when the gate 20 is opened by frictional force generated between the gate 20 and the body 10 and frictional force generated between the gasket 23 and the body 10, the opening may be maintained even though a pressure is slightly lower than the applied pressure to efficiently discharge the gas (for example, when the gas pressure is 0.1 Mpa, if the gate is opened, the gas is discharged to the outside to decrease in gas pressure, and thus, the gate is set so as not to be closed even when the gas pressure is 0.1 Mpa, but to be closed at a pressure of about 0.05 Mpa.

Also, a lubricant and vacuum grease may be additionally applied to the contact portion between the body 10 and the gate 20 to reduce sealing properties and the frictional force, and the lubricant and vacuum grease may be selected from materials that do not react with the electrolyte.

### Second Embodiment

In this embodiment, a valve to which a blocking film 40 that shields a passage 11 in a body 10 of the valve 100 according to the first embodiment is additionally attached.

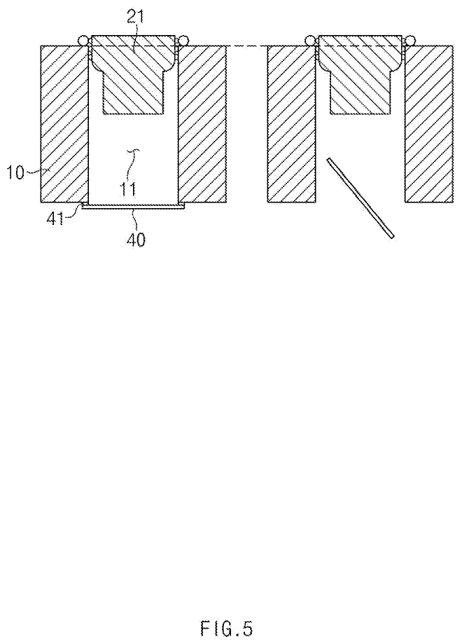

FIG. 5 is a cross-sectional view (left) illustrating a state in which a blocking film is mounted at an inlet-side of a passage and a cross-sectional view (right) illustrating a state in which the blocking film is separated from a mounted position according to a second embodiment of the present invention.

Referring to FIG. 5, the blocking film 40 for preventing an electrolyte from being permeated may be mounted on an inlet-side of the passage 11 in the body 10.

The blocking film 40 is provided to prevent a gas and electrolyte from being unnecessarily introduced into the passage 11 before an internal pressure of the pouch 1 increases.

The blocking film 40 may be configured to be torn or separated from the mounted position when a gas is generated inside the pouch 1 to increase in the internal pressure.

The blocking film 40 is not limited to a specific material as long as the material does not cause a chemical reaction with the electrolyte, but is preferably a material that is capable of being easily torn according to a change in pressure. Alternatively, even if the material is not sensitive to the pressure change, the blocking film 40 may be mounted by adjusting sensitivity of an adhesive 41 by which the blocking film 40 adheres to prevent the blocking film 40 from being separated.

The blocking film 40 according to the present invention is manufactured as a thin film made of polypropylene or polytetrafluoroethylene.

Also, a pressure sensitive adhesive may be used as the adhesive 41 adhering to the blocking film.

In the present invention having the configuration as described above, when the gas is generated inside the pouch 1, and the pressure of the gas overcomes elastic force of a spring 30, the gate 20 may be opened to discharge to a discharge hole 13, thereby efficiently preventing swelling from occurring and preventing moisture and the foreign substances from being introduced from the outside of the valve 100.

An O-ring 15 may be mounted at a point of the hook protrusion, at which the gate 20 is seated, to prevent the electrolyte from leaking.

Furthermore, the blocking film 40 may be mounted on an inlet-side of a passage 11 to fundamentally block introduction of the electrolyte into the valve 100 when the pressure inside the pouch 1 is in the normal range.

The blocking film 40 may be made of a material that does not cause a chemical reaction with the electrolyte to prevent the electrolyte from being deteriorated in performance.

In the valve 100 of the present invention, an auxiliary discharge hole 16 may be formed in an opposite side of the discharge hole 13 to prevent air resistance from adversely affecting sliding of the valve 100.

In addition, a gasket 23 may be filled into the gate 20 to prevent a gas from leaking, and an inclined surface 22a may be formed on a pillar 22 to allow the gas to be gradually discharged.

While the embodiments of the present invention have been described with reference to the specific embodiments, it will be apparent to those skilled in the art that various changes and modifications may be made without departing from the spirit and scope of the invention as defined in the following claims.

### DESCRIPTION OF THE SYMBOLS

10: Body

11: Passage

12: Chamber

13: Discharge hole

14: Gasket

15: O-ring

16: Auxiliary discharge hole

20: Gate

21: Body

22: Pillar

30: Spring

40: Blocking film

100: Valve

1. A secondary battery comprises:
a pouch having an edge that is sealed to form a sealing portion;
an electrode assembly inserted into the pouch;
an electrolyte injected into the pouch; and
a valve fixed to the sealing portion so that one end thereof faces the inside of the pouch, and the other end thereof faces the outside of the pouch,
wherein the valve comprises:
a body forming a passage having opened one end facing the inside of the pouch and provided with a chamber connected to the passage, wherein a discharge hole communicating with the outside is formed in the chamber;
a gate seated on a hook protrusion forming a boundary between the passage and the chamber to open or close the passage; and
a spring mounted to apply elastic force in a direction in which the gate is closed such that a predetermined pressure inside the pouch is configured to overcome the elastic force of the spring to open the gate and allow gas to escape through the discharge hole.

2. The secondary battery of claim 1, wherein an O-ring is mounted at a point of the hook protrusion, at which the gate is seated, so that sealing is achieved when the gate is closed.

3. The secondary battery of claim 1, wherein a blocking film for preventing the electrolyte from being permeated is mounted on the body at an inlet-side of the passage, and
the blocking film may be torn or separated from a mounted position when pressure inside the pouch reaches a sufficient magnitude.

4. The secondary battery of claim 3, wherein the blocking film is made of a material that does not cause a chemical reaction with the electrolyte.

5. The secondary battery of claim 4, wherein the blocking film is manufactured as a thin film made of polypropylene or polytetrafluoroethylene.

6. The secondary battery of claim 3, wherein the blocking film adheres to the body by using a pressure sensitive adhesive.

7. The secondary battery of claim 1, wherein an auxiliary discharge hole is formed so that when the gate slides inside the chamber, air within the chamber is discharged,
wherein the auxiliary discharge hole is formed at an opposite side of the discharge hole with the gate therebetween.

8. The secondary battery of claim 1, wherein the gate comprises a body seated on the hook protrusion and a pillar expanded form the body to protrude to be inserted into the passage,
wherein a gasket having a ring shape is fitted to an outer circumferential surface of the pillar to seal a gap between the outer circumferential surface of the pillar and an inner circumferential surface of the passage.

9. The secondary battery of claim 8, wherein an inclined surface is formed along a circumference of the pillar.

10. The secondary battery of claim 1, wherein the valve is disposed in parallel to an electrode lead that is drawn out from the electrode assembly to protrude out of the pouch.

11. A secondary battery module manufactured by coupling a plurality of secondary batteries of claim 1 to each other.
